(19) United States
(12) Patent Application Publication
(10) Pub. No.: US 2025/0251011 A1
(43) Pub. Date: Aug. 7, 2025

(54) HIGH STRENGTH J-BOLT

(71) Applicant: WHITE MULE COMPANY, Ontario, OH (US)

(72) Inventors: Larry Steven Ritchey, Mansfield, OH (US); Andrew Patrick Ritchey, Mansfield, OH (US)

(21) Appl. No.: 19/043,672

(22) Filed: Feb. 3, 2025

Related U.S. Application Data
(60) Provisional application No. 63/662,519, filed on Jun. 21, 2024.
(60) Provisional application No. 63/550,163, filed on Feb. 6, 2024.

(51) Int. Cl. F16B 35/04

(52) U.S. Cl. CPC F16B 35/041

(57) ABSTRACT

A high strength J-bolt for a saddle-mount is provided for use in attaching the saddle-mount to an axle of a vehicle. The high strength J-bolt can include a round distal end, a tapered and/or round mid-section, and a hook end with a specified inside bend radius and cross-sectional shape configured to accommodate an increased range of axle sizes. A D-shaped cross-sectional shape can be formed for the hook end to provide for increased contact area with the axle, a larger cross-sectional area, and a higher section modulus along a critical bending axis as compared to a non-critical bending axis to maximize a clamping force that can be applied to the axle and militate against mechanical failure of the high strength J-bolt. A hot forging process can be used to form the shape of the high strength J-bolt.

### CROSS-REFERENCE TO RELATED APPLICATIONS

This application claims the benefit of U.S. Provisional Application No. 63/662,519, filed on Jun. 21, 2024, and U.S. Provisional Application No. 63/550,163, filed on Feb. 6, 2024. The entire disclosures of the above applications are incorporated herein by reference.

### FIELD

The present disclosure relates generally to devices for the transportation of vehicles and, more particularly, to an improved J-bolt for coupling vehicles together for transport.

### INTRODUCTION

This section provides background information related to the present disclosure which is not necessarily prior art.

Certain devices are used for coupling vehicles together for purposes of either towing a disabled vehicle or for shuttling one or more vehicles between locations. One such device is a saddle-mount, which is designed to couple a lead vehicle to a towed vehicle or combination of vehicles. A saddle-mount may be used on semi-trucks, tractors, and other large vehicles to tow one or more additional vehicles via the front axle of the towed vehicles. In truck applications, the saddle-mount may be mounted to either the fifth wheel or to the frame of the lead truck. The saddle-mount is then coupled to the front axle of the towed vehicle, such that the front of the towed vehicle is lifted from the ground, and the towed vehicle rolls only on its rear wheels. Alternatively, multiple saddle-mounts may be used in any combination to couple additional trucks. Up to three saddle-mounts may be used, for example, to transport a maximum of four trucks in total, the towing or lead truck and three towed trucks.

A saddle-mount configuration may include a saddle bolster (e.g., the lower half of a saddle-mount) that is used to secure the saddle-mount to either the frame or fifth wheel of the towing or lead vehicle and a saddle head (e.g., the upper half of a saddle-mount) for securing and retaining the front axle of the vehicle being towed.

Certain saddle-mount designs include the use of a rocker body and J-bolt assembly. The rocker body and J-bolt can be configured to receive the front axle of the vehicle being towed and cooperate to provide a clamping force to secure the front axle to the saddle-mount. The J-bolt may be the link in a saddle-mount that limits the clamping force of the rocker and J-bolt assembly. What is more, certain J-bolts may not accommodate various sizes of vehicle axles. In particular, there is a trend in vehicle configurations toward larger vehicles that have larger axles with larger bottom flanges. The fit of the larger bottom flanges with certain J-bolts may not be optimal and may cause undue stress on the J-bolts during operation and lead to shortened service life. Additionally, larger vehicles are typically heavier, necessitating larger tow capacities for the saddle-mount assemblies and associated J-bolts.

Accordingly, there is a continuing need for a high strength J-bolt that is compatible with different sized axles and maximizes a clamping force on the axle and a service life of the J-bolt.

### SUMMARY

In concordance with the instant disclosure, a high strength J-bolt compatible with different sized axles that maximizes a clamping force on the axle and a service life of the J-bolt, has been surprisingly discovered.

In certain embodiments, a high strength J-bolt can include a distal end having a threaded portion and a hook end including an inside bend radius. A section modulus across the hook end can be greater than a section modulus across the distal end.

In certain embodiments, a high strength J-bolt can include a distal end having a threaded portion and a hook end including an inside bend radius. The hook end can include an inside bend radius and can have a D-shaped cross-section. The inside bend radius can define an inner hook portion of the high strength J-bolt. The D-shaped cross-section can provide a substantially flat surface along the inner hook portion of the high strength J-bolt to position a neutral axis of bending of the D-shaped cross-section that is offset toward the substantially flat surface of the D-shaped cross-section to reduce the bending or tensile stress at the hook end of the high strength J-bolt.

In certain embodiments, a method of making a high strength J-bolt from a round steel bar is provided. The method may include one or more of: providing a round steel bar; cutting the round steel bar to a desired length to provide a steel blank; heating the steel blank to facilitate shaping of the steel blank; bending one end of the steel blank to form a hook end of the steel blank; shaping the steel blank using a forging process; trimming material from the steel blank; threading an end opposite the hook end of the steel blank to form the high strength J-bolt.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a high strength J-bolt according to the present disclosure.

FIG. 2 is a right side elevational view of the high strength J-bolt shown in FIG. 1.

FIG. 3 is a front elevational view of the high strength J-bolt shown in FIG. 1.

FIG. 4 is a side elevational view of a saddle-mount on a tow vehicle having a J-bolt assembly secured to a front axle of a vehicle being towed.

FIG. 5 is a side elevational view of a J-bolt assembly showing a vehicle axle secured in the J-bolt assembly including a rocker body and a high strength J-bolt.

FIG. 6 is a perspective view of the J-bolt assembly shown in FIG. 5 without the vehicle axle.

FIG. 7 is a side elevational view of the J-bolt assembly shown in FIG. 6.

FIG. 8a is an enlarged fragmentary side elevational view of the high strength J-bolt of FIG. 1 showing a vehicle axle received in the hook end of the high strength J-bolt.

FIG. 8b is an enlarged fragmentary top perspective view of the high strength J-bolt of FIG. 8a.

FIG. 9a is an enlarged fragmentary side elevational view of a prior art j-bolt showing a vehicle axle received in a hook portion of the prior art j-bolt.

FIG. 9b is an enlarged fragmentary top perspective view of the prior art j-bolt of FIG. 9a.

FIGS. 10A and 10B provide a flow diagram illustrating a method for producing a high strength J-bolt from a round bar, according to an embodiment of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a process reciting elements A, B and C specifically envisions embodiments consisting of, and consisting essentially of, A, B and C, excluding an element D that may be recited in the art, even though element D is not explicitly described as being excluded herein.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

This patent application incorporates by reference the entire disclosure of U.S. Pat. No. 12,077,023 B2, issued on Sep. 23, 2024, from U.S. patent application Ser. No. 17/130,043, filed on Dec. 22, 2020.

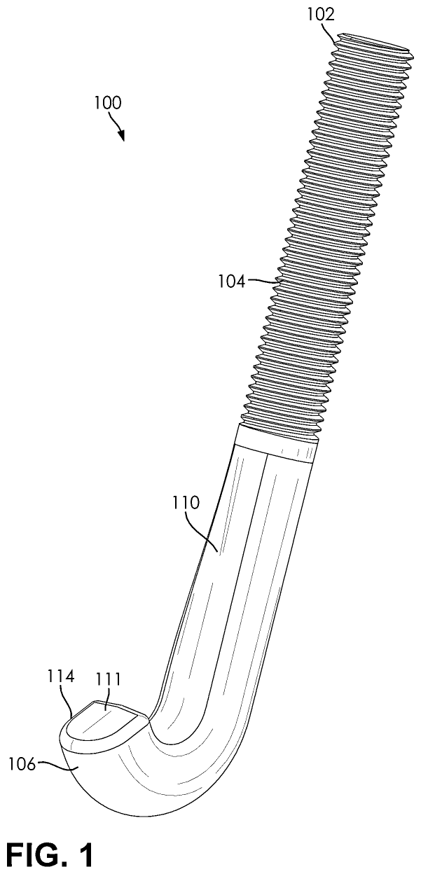

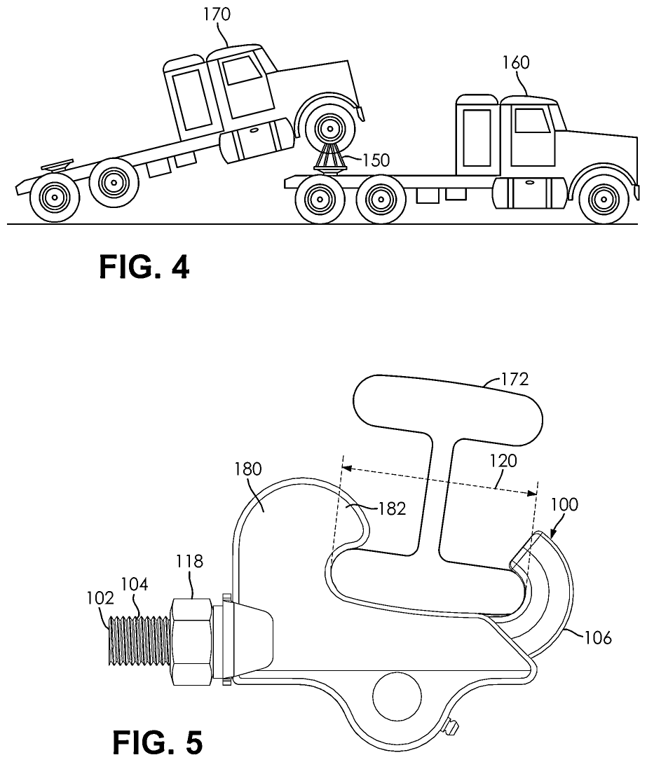

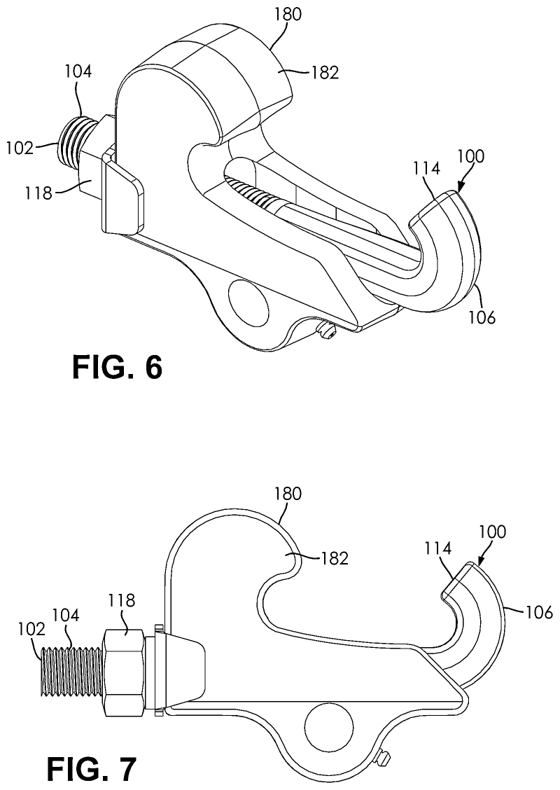

The present technology relates to a high strength J-bolt 100, shown generally in FIGS. 1-3. The high strength J-bolt 100 can be configured to be used in a saddle-mount assembly 150, shown in FIG. 4, to facilitate a lead vehicle 160 pulling one or more towed vehicles 170. More specifically, the high strength J-bolt 100 can be configured to be used with a rocker body 180 of the saddle-mount assembly 150, as shown in FIGS. 5-7. The high strength J-bolt 100 can be configured to accommodate coupling a heavy duty front axle 172 of the towed vehicle 170 to the saddle-mount assembly 150, where the saddle-mount assembly 150 can be coupled to the lead vehicle 160. It should be understood that the high strength J-bolt 100 is not limited to being used with the saddle-mount assembly 150 and rocker body 180. The high strength J-bolt 100 can be used in any application where J-bolts are used or are desired to be used. Dimensions of the high strength J-bolt 100 can be tailored to be compatible with different sized vehicle axles and provide improved resilience and service life by providing a larger cross-sectional area with a higher section modulus in the critical bending axis to maximize strength, improve inside bend radius at the hook end, and be formed by an improved method that enables a greater clamping force to be achieved on the axle of the towed vehicle while militating against mechanical issues including stretching and/or bending of the high strength J-bolt 100.

The threaded portion 104 of the high strength J-bolt can be formed to cooperate with a fastener 118 to facilitate adjusting a distance 120 between the hook end 106 of the high strength J-bolt 100 and a hook portion 182 of the rocker body 180. Adjusting the distance 120 between the hook end 106 of the high strength J-bolt 100 and the hook portion 182 of the rocker body 180 facilities securing the vehicle axle 172 to the saddle-mount assembly 150 and achieving a desired clamping force on the vehicle axle 172 of the towed vehicle 170.

As shown in FIGS. 1-3, the high strength J-bolt 100 can have a distal end 102 including a threaded portion 104 having a length L1 and a diameter D1. The high strength J-bolt 100 can also have a proximal or hook end 106 (e.g., the curved end). The hook end 106 can be defined by an inside bend radius 108. The high strength J-bolt 100 can have an overall length L2. The distal end 102 of the high strength J-bolt 100 can have a diameter D1 of at least 1 inch to facilitate a cut thread process. In other embodiments, the distal end 102 of the high strength J-bolt 100 can have a diameter D1 of about 0.912 inches to facilitate a roll threading process. The diameter D1 of the high strength J-bolt 100 can range from about 0.75 inches to about 1.5 inches. In certain embodiments, the diameter D1 of the high strength J-bolt 100 can be about 1 inch to about 1.125 inches. It should be understood that other diameters can be selected, as desired or needed for a particular use.

The hook end 106 of the high strength J-bolt 100 can have a diameter and/or thickness and/or cross-sectional area larger (i.e. larger cross-sectional dimensions) than the distal end 102. The high strength J-bolt 100 can be tapered from the larger dimensions of the hook end 106 to the diameter D1 of the threaded portion 104 and distal end 102 along a middle section 110 of the high strength J-bolt 100. The larger dimensions of the hook end 106 as compared to the distal end 102 provides the hook end 106 with a higher section modulus as compared to the distal end 102. In particular, the larger dimensions of the hook end 106 provide a higher section modulus and increased strength along a critical bending axis associated with tensile forces acting in a manner to straighten and/or increase the inside bend radius 108 of the hook end 106. It should be understood that the relative increase in section modulus of the hook end 106 as compared to the distal end 102 can be achieved with any length and/or size of the high strength J-bolt 100 to increase the strength of the hook end 106 of the high strength J-bolt 100.

In certain embodiments, the cross-section area of the hook end 106 can have a D-shaped cross-section 111 to provide the larger cross-sectional area and higher section modulus of the hook end 106 as compared to the distal end 102. The cross-sectional shape of the hook end 106 can include a substantially flat portion formed on the inner hook area defined by the inside bend radius 108, such as the flat portion of the D-shaped cross-section 111. It should be understood that the cross-section area of the hook end 106 can have other shapes such as square, rectangular, triangular, or other shapes to provide a desired section modulus and increased strength along the critical bending axis to resist tensile forces acting in a manner to straighten and/or increase the inside bend radius 108 of the hook end 106 as compared to the section modulus along non-critical bending axes such as the section modulus of the distal end 102 that is round. The cross-sectional shape of the middle section 110 can also be square, rectangular, oval, an I-beam, or other round or non-round shapes to provide the transition from the threaded portion 104 to the hook end 106 having the increased section modulus and strength along the critical bending axis as compared to the non-critical bending axes of the distal end 102.

The high strength J-bolt 100 can be formed of a variety of suitable materials known to those of skill in the art. The high strength J-bolt 100 can include metals, including alloys, metallic composite materials, steel, elastomers, polymers, etc. In a particular embodiment, the high strength J-bolt 100 can be formed of 1541 steel. In other embodiments, the high strength J-bolt 100 can be formed of 4140 steel. In yet other embodiments, the high strength J-bolt 100 can be formed of 4340 steel. Other suitable materials known to those of skill in the art can also be used to form the high strength J-bolt 100, as desired or needed for a particular use.

Certain embodiments of the high strength J-bolt can be a Grade 8 equivalent. Those skilled in the art will understand that the Grade refers to bolt grades suitable for certain applications and environments. The minimum yield strength of a Grade 8 bolt is about 130,000 pounds per square inch (psi). Some Grade 8 bolts can have a tensile strength of about 150,000 psi. A maximum of about 120,000 psi of tensile force, scilicet, proof load, can be applied to grade 8 bolts. These embodiments can have a Rockwell C Hardness (HRC) of about 33-39. In other embodiments, the high strength J-bolt 100 can be heat treated to a Grade 9 equivalent. These examples can have a tensile strength of about 180,000 psi. These embodiments can have a Rockwell C Hardness (HRC) of about 38-42. It should be understood that the high strength J-bolt 100 can be heat treated to a achieve other hardness grades, as desired or needed for a particular use.

The overall length L2 of the high strength J-bolt 100 can be about 2 inches to about 15 inches. In certain embodiments, the length L1 of the threaded portion 104 of the high strength J-bolt 100 can be about 3 inches, about 5 inches, about 7 inches, about 10 inches, or about 12 inches. The threaded portion 104 of the high strength J-bolt 100 can be formed by cutting the threads. In other embodiments, the threaded portion 104 can be created by roll forming. It should be appreciated that cutting the threads severs the steel grain structure to produce the threads. Conversely, cold forming processes, such as roll threading, can cause the steel grain to flow in multiple directions. Roll threading typically involves a set of hardened steel dies, used to apply pressure to the bolt. It should be understood that one skilled in the art can form the threaded portion 104 of the high strength J-bolt 100 by thread cutting or roll forming as desired or needed based on particular manufacturing needs or end use of the high strength J-bolt 100.

The inside bend radius 108 can be about 0.5 inches to about 0.8 inches. In a more specific embodiment, the inside bend radius 108 of the high strength J-bolt 100 can be about 0.5 inches to about 0.68 inches. In certain embodiments, the inside bend radius 108 can be about 0.63 inches. In other embodiments, the inside bend radius 108 can be about 0.5 inches. It should be understood that one skilled in the art can select other dimensions for the inside bend radius 108 as desired or as need to facilitate a desired interface with a surface of an object in contact with the inside surface of the hook end 106.

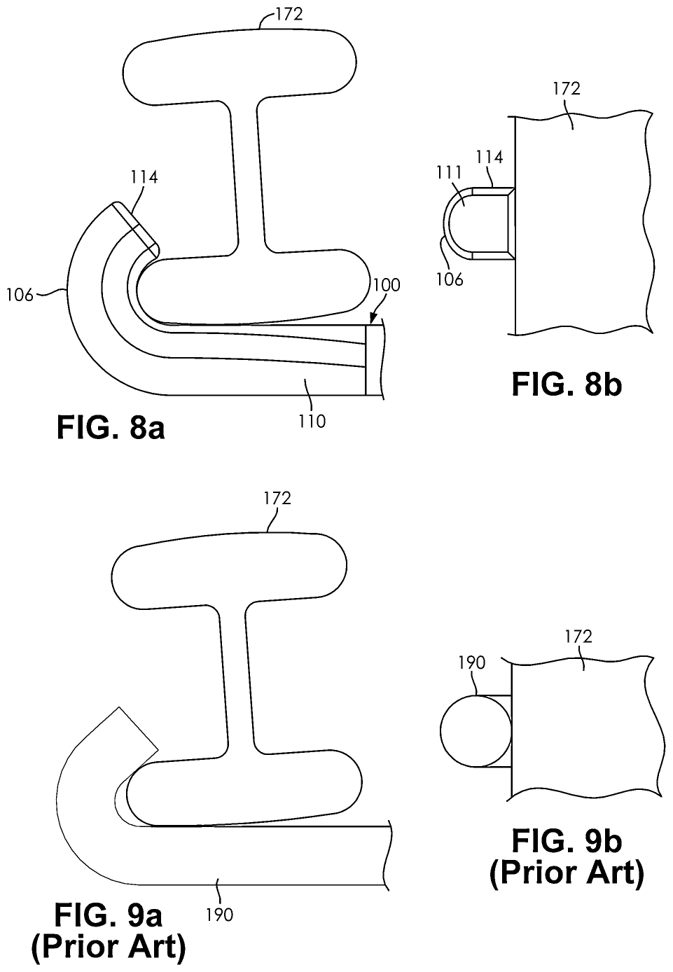

In certain embodiments, the inside surface of the hook end 106 defined by the inside bend radius 108 can be substantially smooth, militating against deformation, mechanical failure, and/or structural failure. It should be appreciated that the inside bend radius 108 can be altered by those of skill in the art to accommodate new designs, improvements, and advancements in axles and/or bottom flanges of vehicle axles, other vehicle components, and shapes and sizes of other objects to which the high strength J-bolt 100 can be coupled. More specifically, the inside bend radius 108 can include a portion that is configured to maximize contact with the vehicle axle 172, as show in FIGS. 8a and 8b. This can allow the vehicle axle 172 to fully seat into the high strength J-bolt 100, decreasing the likelihood of mechanical failure, structural failure, or deformation of the high strength J-bolt 100. The inside bend radius 108 of the high strength J-bolt 100 can be made to substantially match the radius of the bottom portion or bottom flange of the vehicle axle 172, as shown in FIGS. 8a and 8b. The vehicle axle 172 can be completely or nearly coincident with the surface of the inside bend radius 108. Having an improved inside bend radius 108 on the hook end 106 of the high strength J-bolt 100, allows the high strength J-bolt 100 to accept certain vehicle axles 172 and nest tightly therewith. This can reduce the mechanical force from the vehicle axles 172, thereby minimizing the incidence of mechanical failure. In comparison, FIGS. 9a and 9b show a prior art round cross-section J-bolt 190 interfacing with a vehicle axle 172 and illustrate the limited contact points between the J-bolt 190 and the vehicle axle 172 as compared to the high strength J-bolt 100 shown in FIGS. 8a and 8b.

The inside bend radius 108 of the high strength J-bolt 100 provided by the present technology can be selected to accommodate the largest axles currently in production or to facilitate use of the high strength J-bolt 100 in other selected applications. It should be understood that the hook end 106 can have shapes and/or profiles other than a curved profile defined by a bend radius. For example, the shape and/or profile can include straight portions and combinations of straight and curved or radiused portions to form a desired shape to facilitate receiving a vehicle axle or other selected objects.

It should be appreciated that the high strength J-bolt 100 can have a variety of different cross-sections along the middle section 110 as the high strength J-bolt transitions from the threaded portion 104 to the hook end 106. In particular, the cross-sectional shape can transition from the round cross-sectional shape of the threaded portion to another cross-sectional shape starting at a location adjacent to the termination of the threaded portion 104. The cross-section area can transition from the round cross-sectional shape adjacent the threaded portion 104 to the D-shaped cross-section 111 shape of the hook end 106. The cross-sectional shape of the middle section 110 can vary along a length thereof and can include portions that are round, D-shaped, or other shapes as desired and suitable for selected manufacturing processes and end use applications.

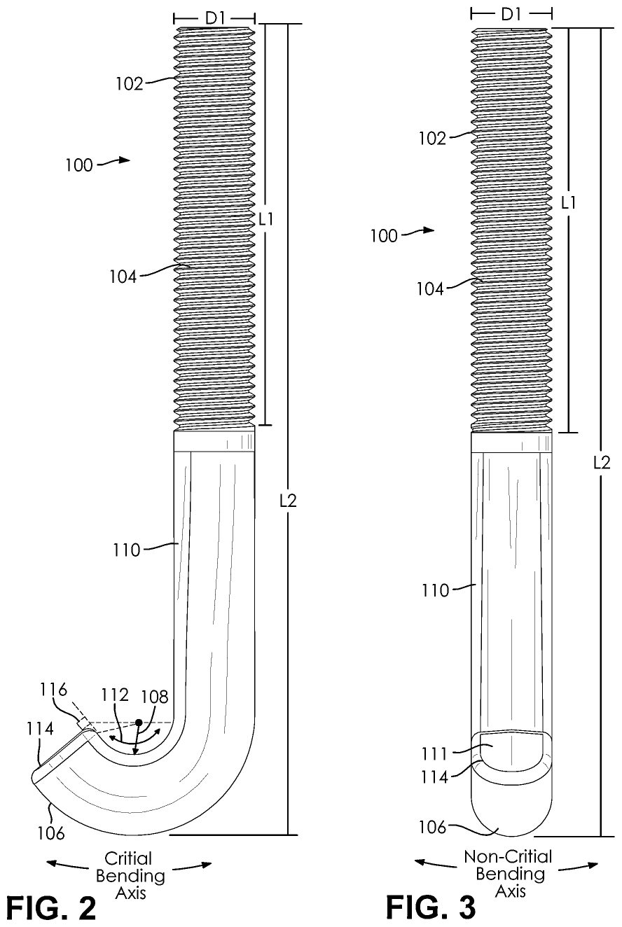

As shown in FIGS. 1-3 the D-shaped cross-section 111 of the hook end 106 of the high strength J-bolt 100 militates against a bending of the high strength J-bolt 100 along a critical bending axis, wherein the D-shape cross-section 111 provides a first section modulus across the critical bending axis that is greater than the second section modulus across the non-critical bending axis (e.g., as shown in FIGS. 2 and 3). What is more, the D-shaped cross-section 111 provides a substantially flat surface having an optimized width for the inner surface of the hook end 106. The D-shaped cross-section 111 locates or offsets the neutral axis of bending closer to the substantially flat surface of the hook end 106 and, when placed under a tensile load, reduces the tensile stress and/or bending stress applied to the substantially flat surface as compared to J-bolts having a round cross-sectional shape. Furthermore, the D-shaped cross-section 111 of the high strength J-bolt 100 can provide a substantially flat surface along the inner hook portion of the high strength J-bolt 100 to maximize a cross-sectional area of the hook end 106 adjacent the inner hook portion. The maximized cross-sectional area can reduce the bending or tensile stress at the hook end 106 of the high strength J-bolt 100 for a given applied load as compared to J-bolts having a round cross-sectional shape. When J-bolts are placed under a tensile load, one failure mode can be a tensile related failure that initiates in the area of the inner surface hook portion of the high strength J-bolt 100. The D-shaped cross-section 111 of the high strength J-bolt 100, or other cross-sectional shapes that provide a substantially flat surface along the inner hook portion of the high strength J-bolt 100, can reduce the tensile stress in this location and thus militate against a tensile failure.

Certain embodiments of the high strength J-bolt 100 can include a protective finish on the outer surface of the high strength J-bolt 100. The protective finish can be corrosion resistant and provide protection against the introduction of hydrogen, oxygen, rust formation, and oxidation. The protective finish can include brass, bronze, chrome, nickel-plating, phosphate, such as grey phosphate, phosphate and oil, a ceramic coating, a black oxide coating, and zinc, including a hot-dipped galvanized coating; and an electro galvanized coating. The protective finish can be formed by one of: cold bluing; hot bluing; rust bluing; niter bluing; color case hardening; browning; and fume bluing. In other embodiments, the protective finish can be formed by one of: hot black oxide; mid-temperature black oxide; and cold black oxide. In yet other embodiments, the protective finish can be one of a zinc coating and a phosphate and oil coating. A person of skill in the art can further appreciate that the protective finish can include application of a corrosion resistant material to increase the longevity of the high strength J-bolt 100. It should also be appreciated that certain embodiments of the high strength J-bolt 100 can be formed out of a corrosion resistant material. Non-limiting examples of the corrosion resistant materials include steel, stainless steel, and other suitable alloys known to those of skill in the art.

The high strength J-bolt 100 can include a short or truncated tip or nose to militate against the tip/nose of the high strength J-bolt 100 from contacting the center web of an I-beam front axle and causing deformation and or mechanical failure of the high strength J-bolt 100 during use. The D-shaped cross-section 111 of the hook end 106 provides for both maximized cross-sectional area and maximized clearance between the tip/nose of the high strength J-bolt 100 and the center web of the I-beam front axle. The reduced distance from the tip/nose of the high strength J-bolt 100 to the inner surface defined by the inside bend radius 108 enables the high strength J-bolt 100 to be used with wider range of I-beam axles, including smaller I-beam axles where the distance between the outer edge of the beam and the beam web can be minimal.

With reference to FIG. 2, the curved inner surface of the hook end 106 can have an arc 112 of less than 180 degrees and can be about 150 degrees or less. It should be understood that one skilled in the art can select an angle defining the length of the arc 112 as desired and suitable for selected manufacturing processes and end use applications. Furthermore, a terminal end 114 of the hook end 106 can be formed at an angle 116 substantially perpendicular to the curved inner surface adjacent to the termination of the curved inner surface. One skilled in the art can select an angle 116 as desired and suitable for selected manufacturing processes and end use applications.

Advantageously, the high strength J-bolt 100 is compatible with many existing products on the market. The high strength J-bolt 100 is more resilient than other J-bolt designs. Additionally, the high strength J-bolt 100 has a larger cross-sectional area and a higher section modulus and an improved inside bend radius, which in combination provides a greater clamping force on the axle and militates against deformities and mechanical failure. Specifically, the high strength J-bolt 100 militates against a bending of the high strength J-bolt 100 along the critical bending axis, wherein the D-shape cross-section 111 provides a first section modulus across the critical bending axis that is greater than a second section modulus across a non-critical bending axis and can reduce the tensile stress and/or bending stress applied to the substantially flat surface of D-shaped cross-section 111 of the hook end 106.

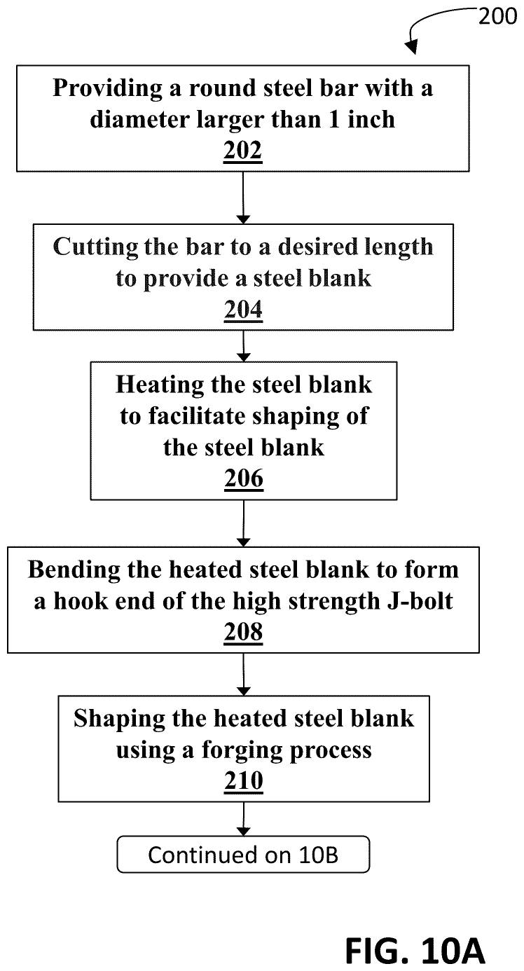

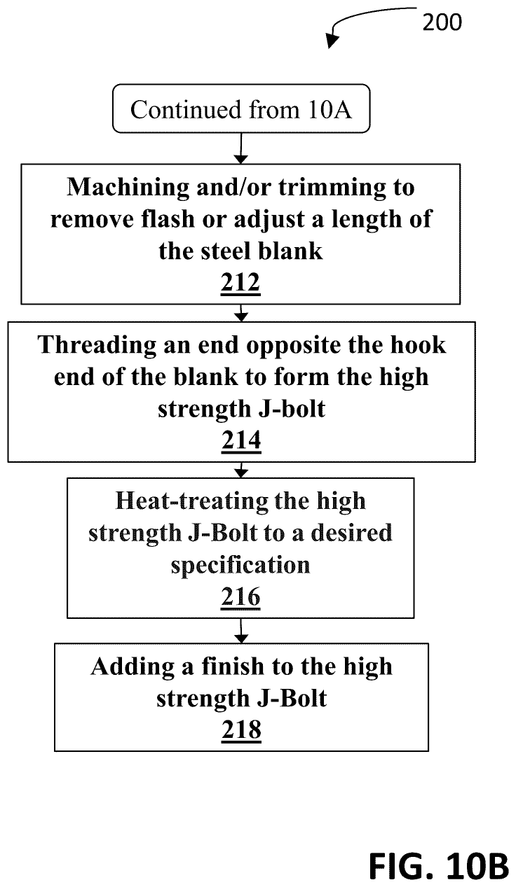

FIGS. 10A and 10B show a method 200 of making the high strength J-bolt 100 shown in FIGS. 1-3. It should be appreciated that the following steps can occur in various order with respect to each other, including where certain steps can be performed simultaneously, or with other steps. It should be understood that various types of steel can be used as well as non-steel materials. In a first step 202, a round steel bar with a diameter larger than 1 inch can be provided. The steel bar can have a diameter of at least 1 3/16 of an inch. Other diameters can be used, including bars having a diameter of about 1 inch, about % an inch, or other diameters less than or greater than 1 inch. In a second step 204, the bar can be cut to a desired length to provide a steel blank. In a third step 206, the steel blank can be heated to facilitate the shaping of the steel blank. In a fourth step 208, the heated steel blank can be bent to form the general J-shape of the high strength J-bolt 100. In a fifth step 210, the heated steel blank can be shaped using a forging process that utilizes a die to smash and/or crush the heated steel blank bolt to form the desired inside bend radius 108 as well as the desired tapers and cross-sectional shapes along the length of the high strength J-bolt 100. The tapers and cross-sectional shapes formed in the forging process can include the round cross-sectional shape of the distal end 102, the desired transitional shape through the middle section 110, and the D-shaped or other cross-sectional shapes through the hook end 106 as well as the inside bend radius 108 of the high strength J-bolt 100. Utilizing a hot forging process to shape the high strength J-bolt 100 maximizes a strength of the high strength J-bolt 100 as compared to using cold shaping processes.

The shaped steel blank can be machined and/or trimmed to remove flash or adjust a length of the high strength J-bolt 100 in a step 212. In a seventh step 214, the distal end of the blank can be threaded. The threads can be formed utilizing a machining process to remove material to produce the threaded portion or by utilizing a roll forming process to produce the threaded portion. The high strength J-bolt 100 can be hardened to a desired specification in an eighth step 216. In a ninth step 218, a finish can be added to the surface of the high strength J-bolt 100 which can provide a desired appearance and protect the high strength J-bolt 100 from corrosion, for example.

Example embodiments are provided so that this disclosure will be thorough, and will fully convey the scope to those who are skilled in the art. Numerous specific details are set forth such as examples of specific components, devices, and methods to provide a thorough understanding of the embodiments of the present disclosure. It will be apparent to those skilled in the art that specific details need to be employed, that example embodiments may be embodied in many different forms, and that neither should be construed to limit the scope of the disclosure. In some example embodiments, well-known processes, well-known device structures and well-known technologies are not described in detail. Equivalent changes, modifications, and variations of some embodiments, materials, compositions, and methods may be made within the scope of the present technology, with substantially similar results.

What is claimed is:

1. A high strength J-bolt, comprising:
a distal end including a threaded portion; and
a hook end including an inside bend radius, wherein a section modulus across the hook end is greater than a section modulus across the distal end.

2. The high strength J-bolt of claim 1, wherein the hook end includes a section modulus that is greater in a critical bending axis than a non-critical bending axis.

3. The high strength J-bolt of claim 1, wherein the distal end includes a round cross-section and the hook end includes a D-shaped cross-section, the inside bend radius defining an inner hook portion of the high strength J-bolt, the D-shaped cross-section providing a substantially flat surface along the inner hook portion of the high strength J-bolt to maximize a cross-sectional area of the hook end adjacent the substantially flat surface to reduce a bending or tensile stress at the hook end of the high strength J-bolt.

4. The high strength J-bolt of claim 1, wherein the high strength J-bolt includes a tapered section between the distal end and the hook end.

5. The high strength J-bolt of claim 1, wherein the inside bend radius is in a range of about 0.5 inches to about 0.68 inches.

6. The high strength J-bolt of claim 1, wherein the inside bend radius is about 0.5 inches.

7. The high strength J-bolt of claim 1, wherein the inside bend radius has an arc length less than about 180 degrees.

8. The high strength J-bolt of claim 1, wherein the inside bend radius has an arc length of about 150 degrees.

9. The high strength J-bolt of claim 1, wherein the high strength J-bolt is formed out of one of a 4140 steel, a 4340 steel, and a 1541 steel.

10. The high strength J-bolt of claim 1, wherein the high strength J-bolt is heat treated to a grade 8 equivalent.

11. The high strength J-bolt of claim 1, wherein the threaded portion has a length of about 3 inches to about 12 inches.

12. The high strength J-bolt of claim 1, wherein the high strength J-bolt has a length in a range of about 2 inches to about 15 inches.

13. The high strength J-bolt of claim 1, further comprising a finish.

14. The high strength J-bolt of claim 13, wherein the finish on the high strength J-bolt includes one of: a zinc plating; a phosphate and oil; a cold bluing; a hot bluing; a rust bluing; a niter bluing; a color case hardening; a browning; a fume bluing; a hot black oxide; a mid-temperature black oxide; and a cold black oxide.

15. A J-bolt assembly for coupling to a front axle, comprising:
a high strength J-bolt according to claim 1; and
a rocker body configured to receive the high strength J-bolt and couple the front axle therebetween.

16. The J-bolt assembly of claim 15, further comprising a fastener configured to cooperate with the threaded portion of the distal end of the high strength J-bolt, the fastener configured to adjust a distance between the hook end of the high strength J-bolt and the rocker body.

17. The J-bolt assembly of claim 16, further comprising a saddle mount assembly configured to be coupled to the rocker body.

18. A high strength J-bolt, comprising:
a distal end including a threaded portion; and
a hook end including an inside bend radius and having a D-shaped cross-section, the inside bend radius defining an inner hook portion of the high strength J-bolt, the D-shaped cross-section providing a substantially flat surface along the inner hook portion of the high strength J-bolt to position a neutral axis of bending of the D-shaped cross-section that is offset toward the substantially flat surface of the D-shaped cross-section to reduce a bending or tensile stress at the hook end of the high strength J-bolt.

19. A method of making a high strength J-bolt including:
providing a round steel bar,
cutting the round steel bar to a desired length to provide a steel blank;
heating the steel blank to provide a heated steel blank to facilitate bending and shaping of the steel blank;
bending one end of the steel blank to form a hook end of the steel blank;
shaping the steel blank using a forging process;
trimming material from the steel blank; and
threading an end opposite the hook end of the steel blank to form the high strength J-bolt.

20. The method of making a high strength J-bolt of claim 19, including:
heat treating the high strength J-bolt to a desired specification; and
adding a finish to the high strength J-bolt.
